(19) United States
(12) Patent Application Publication
(10) Pub. No.: US 2003/0077206 A1
(43) Pub. Date: Apr. 24, 2003

(54) Parallel reactor with gas loading cassette for testing heterogeneous catalysts

(76) Inventors: Gunter Metz, Leverkusen (DE); Olaf Gluck, Koln (DE); Holger Orzesek, Gelsenkirchen (DE); Michael Venz, Dormagen (DE); Gerhard Wegener, Mettmann (DE); Markus Dugal, Koln (DE)

Correspondence Address: BAYER CORPORATION, PATENT DEPARTMENT, 100 BAYER ROAD, PITTSBURGH, PA, 15205, US

(21) Appl. No.: 10/128,932

(22) Filed: Apr. 24, 2002

(30) Foreign Application Priority Data
Apr. 27, 2001 (DE) 10121103.1

(51) Int. Cl. B01J 19/00

(52) U.S. Cl. 422/102; 422/130

(57) ABSTRACT

A reactor and a process for carrying out parallel reactions on solids is described. The reactor comprises at least a sample holder block (1) with a multiplicity of reaction vessels (2a-2k), a heated support structure (3) and a cover (8, 9, 10) sealing all the reaction vessels (2a-2k). The cover (8, 9, 10) contains feed lines (4a-4k) and discharge lines (5a-5k) to each sample vessel (2a-2k). The feed lines (4a-4k) and/or the discharge lines (5a-5k) are joined together by means of feed and discharge channels (7, 8) running crosswise to said lines. The feed and discharge channels (7, 8) end in main fluid feed lines (11) and discharge lines (12).

### BACKGROUND OF THE INVENTION

The present invention relates to a reactor and to a process for carrying out parallel tests on heterogeneous catalysts in which the catalysts being tested were synthesized by a parallel production process.

Facilities for the parallel synthesis of inorganic catalyst materials are described in U.S. Pat. Nos. 5,985,356 and 6,004,617. In these disclosed apparatus, arrays of materials are produced in defined regions of pre-formed substrate surfaces by the controlled application of precursor compounds using ink jet technology and by means of a suitable after-treatment.

By far the major difficulty in combinatorial catalyst research is the development of a suitable test system with which the maximum analytical information may be obtained with the largest possible sample throughput. These problems are discussed in connection with gas phase reactions in published patent specifications WO 98/07026, WO 99/41005 and in U.S. Pat. No. 6,149,882. WO 98/07026 describes a device in which a metal block is provided with miniaturized reactors bored into it which reactors may be loaded with catalysts. The starting products of the reaction may be fed through the catalyst bed by means of a feed/discharge system and the product stream analyzed spectroscopically by means of built in bored cell holes.

WO 99/41005 discloses the parallel operation of reactors in tube bundles in which the catalysts to be tested are produced on the inner walls of the reactor or on auxiliary support materials themselves and may be brought into contact there with the reaction fluid. The product streams may be analyzed by gas chromatography or mass spectrometry by sampling by means of a controllable intake line.

U.S. Pat. No. 6,149,882 also describes a parallel fixed bed reactor in which a multiplicity of reactor vessels are combined in one block. This fixed bed reactor is constructed on a modular basis from a vessel holder, a base block and a cover plate. Catalyst samples may be introduced into the reactor vessels fitted with a frit and through which samples a test fluid may then be passed. The composition of the test fluid after contact with the catalyst may be determined by gas chromatography after samples have been removed online from the various test fluid outlets (1 outlet per reactor) by means of a valve switch.

It is possible to test heterogeneous catalysts in parallel with the known processes. If a greater information content is required from the screening than is available, e.g., by thermography, testing the catalysts not only requires a large amount of equipment but is also associated with time-consuming operating steps such as loading the individual fixed bed reactors integrated in the test unit with separately synthesized catalyst samples, or elaborate coating of individual reactor tubes.

### SUMMARY OF THE INVENTION

An object of the present invention is to provide a process for screening heterogeneous catalysts in which, with a small amount of equipment, few operating steps and in a non time-consuming manner, large arrays of catalysts synthesized in parallel may be tested in a parallel manner in gas phase reactions with the highest possible analytical information content.

It is another object of the present invention to provide a reactor suitable for carrying out the process of the present invention.

These and other objects which will be apparent to those skilled in the art are achieved by a process in which the reactions being conducted to test the catalysts are carried out in a specially prepared reactor having a multiplicity of integrated miniaturized reaction vessels and the reaction mixture is analyzed according to its nature and the amount of product generated during the reaction period. The large arrays of heterogeneous catalysts being tested are synthesized in parallel and are transferred to the reactor without transfer steps and analyzed in the reactor for their catalytic properties.

### BRIEF DESCRIPTION OF THE DRAWINGS

FIG. 1 is a schematic cross-section through the cover of a reactor according to the invention.

FIG. 2 is a longitudinal section through the reactor illustrated in FIG. 1 along the line A-A.

FIG. 3 is an enlargement of the reactor illustrated in FIG. 2.

FIG. 4 is a diagram which illustrates the sampling device 16.

### DETAILED DESCRIPTION OF THE INVENTION

The present invention is directed to a reactor and to a process for efficiently carrying out parallel tests, particularly on heterogeneous catalysts. Preferably, the catalysts being tested have been synthesized in a parallel manner.

The reactor of the present invention is constructed from a sample holder block with a multiplicity of reaction vessels, a heated support structure and a sealing cover, the cover containing feed lines and discharge lines to each reaction vessel. The feed and/or discharge lines are joined together by means of feed and discharge channels running crosswise to the feed and/or discharge lines. The feed and discharge channels end in main fluid feed and discharge lines. Preferably, at least one mass rate of flow controller is provided advantageously in the region of the main fluid feed lines.

In a particularly preferred embodiment, the reactor includes reaction vessels arranged in a matrix of at least 100, preferably at least 1000, individual vessels in the sample holder block.

In a preferred embodiment of the reactor, the cover is designed in two parts. The upper part contains the feed and discharge channels.

A particularly preferred embodiment of the reactor of the present invention is one in which the cover has an additional cover plate with bored holes corresponding to the number of reaction vessels and is provided with a multiplicity of septa or a septum plate and in which one septum is assigned to each reaction vessel. The septa or the septum plate are preferably arranged above the feed lines.

In another preferred embodiment of the reactor of the present invention, the cover is provided with an additional septum plate which is arranged above the reaction vessels and is composed preferably of silicone rubber.

In a further particularly preferred embodiment of the reactor of the present invention, the reactor is connected to a chromatography system, particularly a gas chromatography system. The connection may be made by means of a program-controlled sampling head movable in three spatial directions and having a plurality of sample capillaries, preferably at least two, more preferably at least four, most preferably at least eight sample capillaries, which are able to dip into the reaction vessels through the septum plate for the collection of individual samples.

The present invention also provides a process for carrying out test reactions in parallel, particularly on catalysts. In this process, a) a series of first reactants A is provided in a set of reaction vessels; b) additional reactants B, and optionally C, are added to form the library of reaction mixtures M₁-Mₖ; c) the reaction mixtures M₁-Mₖ are allowed to react, optionally at elevated temperature, over a specified period to form a product which is preferably an inorganic solid; d) any volatile compounds present may be removed from the solids by after-treatment at elevated temperatures; and e) catalyzed gas phase reactions are carried out in parallel on the catalysts formed in the prior steps and the reaction products of the gas phase reaction are analyzed and suitable catalysts are selected on the basis of their efficiency relative to the gas reaction.

The process is preferably carried out in a reactor corresponding to that of the present invention.

In a preferred embodiment of the process of the present invention, the reactants A) are selected from the series comprising metal salts or semi-conductor salts, particularly halides, nitrates, sulfates, oxides, acetates, acetylates, alkoxides, carbonates or carboxylates. These are preferably used in dissolved form in water or an organic solvent, preferably an alcohol, ether, ester or ketone. The metals or semi-conductors are most preferably elements from the series which include Ti, Zr, Hf, Sc, Y, La, V, Nb, Ta, Cr, Mo, W, Mn, Re, Fe, Ru, Os, Co, Rh, Ir, Ni, Pd, Pt, Cu, Ag, Au, Ge, Sn, Sb, Bi, Li, K, Na, Rb, Cs, Mg, Ca, Sr, Ba, B, Al, Si, Ce, Pr, Nd, Dy, Ho, Er, Tm, Yb, Lu. The reactant B may be water or any inorganic material, particularly metal or semi-conductor oxides from the above-mentioned series of metals, and the reactant C) may be a mineral acid, particularly HCl, H₂SO₄, HNO₃, an organic acid such as acetic acid, formic acid, toluenesulfonic acid or a basic compound such as NH₃, an alkali hydroxide, particularly NaOH, KOH, or a fluoride such as sodium fluoride of ammonium fluoride. The reaction may be a hydrolysis and condensation reaction with sol-gel formation or a precipitation reaction or a surface chemisorption or adsorption reaction.

Another preferred embodiment of the process of the present invention employs propene and oxygen, optionally, in addition, hydrogen as the gaseous reactants for the catalyzed reaction. In a particularly preferred embodiment, the gaseous reactants are mixed prior to the reaction with an inert gas, preferably with nitrogen, noble gases, most preferably argon, neon or helium in a ratio of volumes of at least 70:30, preferably at least 50:50 (reactants to inert gas).

In the preferred process, the amount of propylene oxide formed is preferably used as a measure of the efficiency of the solid catalyst. In a further preferred embodiment, reactant A) used in the process is a metal carbonate, metal nitrate or metal carboxylate which changes to an oxidic solid catalyst due to thermal decomposition.

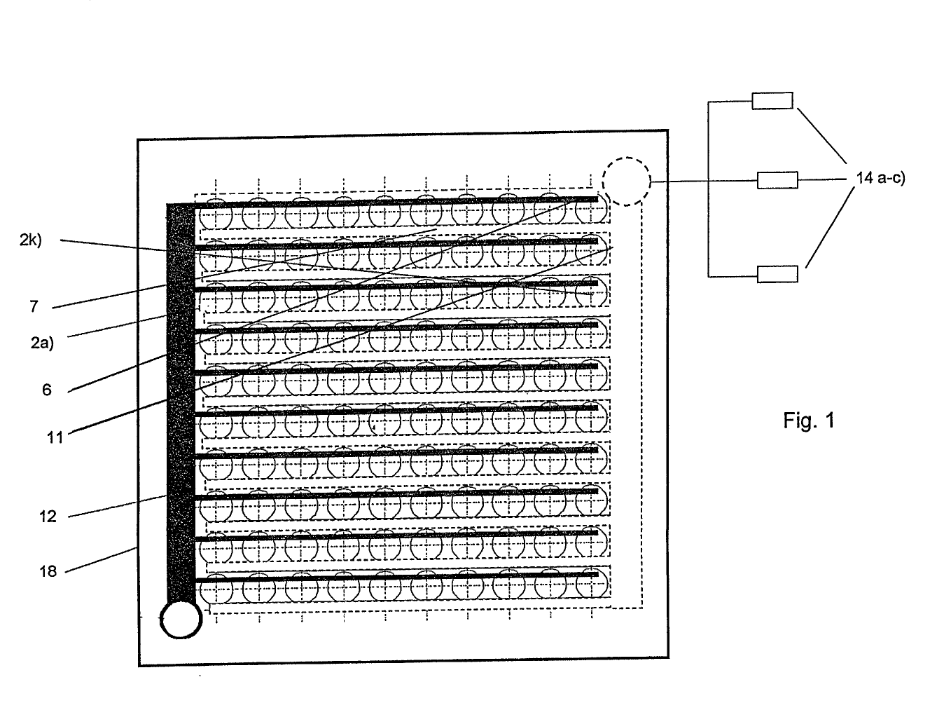

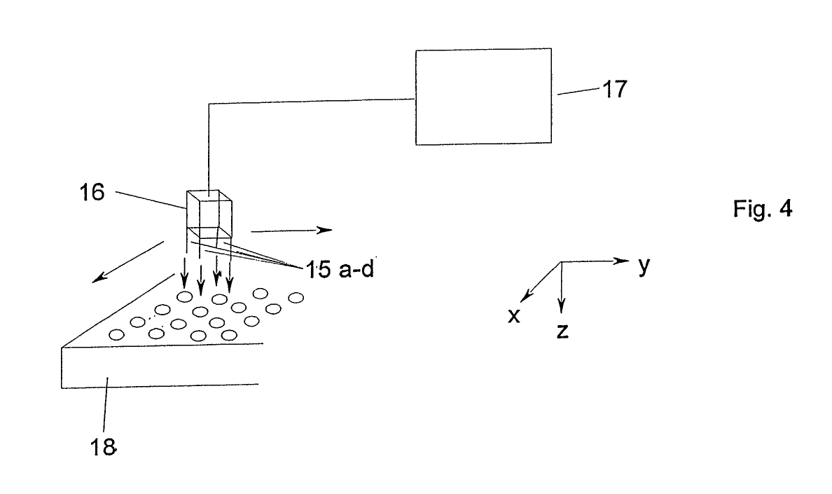

A preferred embodiment of the reactor of the present invention is explained in more detail below with reference to FIGS. 1 through 4.

### EXAMPLE

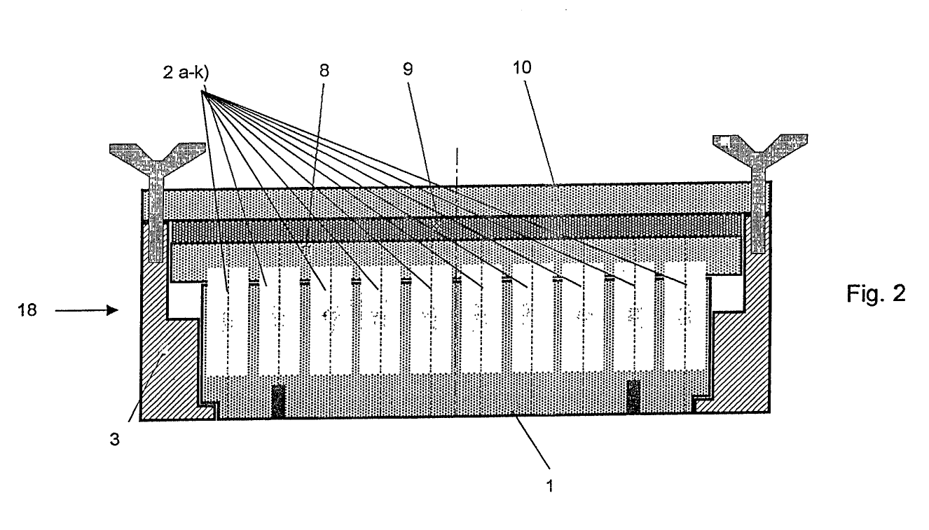

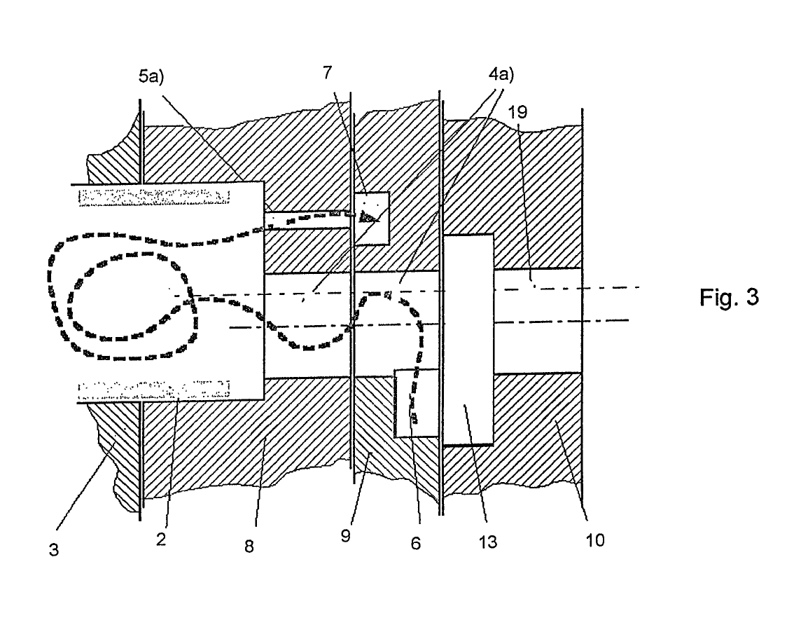

A reactor 18 for carrying out parallel reactions on solids including a sample holder block 1 (FIG. 1) with a multiplicity of reaction vessels 2a-2k, a heated support structure 3 (FIG. 2) and a cover 8, 9, 10 sealing all the reaction vessels. The cover 8, 9, 10 contains feed lines 4a-4k and discharge lines 5a-5k to each sample vessel 2a-2k, the feed lines 4a-4k and/or the discharge lines (5a-5k) being joined together by means of feed channels 6 and discharge channels 7 running crosswise to said lines, and the feed and discharge channels 6, 7 end in main fluid feed lines 11 and discharge lines 12 was used in this Example. The cover 8, 9, 10 of the reactor is made up a cover plate 10 which is provided with a number of bored holes 19 corresponding to the number of sample vessels and a septum plate 13 of silicone rubber, so that one bored hole 19 and the septum plate 13 are present over each sample vessel 2a-2k, and the septum plate 13 is arranged directly over the feed line 4a-4k (See FIG. 3.). The number of reactor vessels 2a-k in one sample holder block 1 of the type described is 100. These reactor vessels are arranged in a matrix of 10×10 chambers. The gas input quantities are controlled by a mass rate of flow controller 14a-c. The reactor 18 can be connected to a gas chromatograph 17 by means of a program-controlled sampling head 16 movable in the x, y and z direction and having four sample capillaries 15a-d, the capillaries 15a-d being able to dip into selected sample vessels through the septum plate 13 for the collection of individual samples.

A test example for testing solid catalysts synthesized in parallel beforehand is described below:

With the aid of micro-metering pumps, 16 different combinations of selected precursor components for sol-gel materials (see Table I) were fed by means of a program-controlled 16-fold metering head into a matrix arrangement of 100 glass vessels in an aluminum sample holder block 1 (10×10) and reacted with one another with shaking. The formulations for the resulting sol-gel materials were generated in an input file and converted to a control file for metering. (See Table 2.) The sol-gel materials obtained were given a thermal after-treatment in sample holder block 1 in accordance with the test conditions shown in Table 2, and the sample holder block 1 was then inserted in the reactor 18 in accordance with the invention.

Into the reactor 18 heated to 200° C., a stream of a mixture of 23.7% propylene, 19.7% oxygen and the remainder nitrogen was brought into contact with the sol-gel solid catalysts situated in the individual reaction vessels 2a-2k. The composition of the corresponding gas samples was determined by automatic sampling from the gas space situated above the individual samples followed by GC analysis, and statistics for the efficiency of the various catalysts of the gas samples were calculated from the ratio of propylene oxide to propylene. The analytical data for the 100 catalysts tested in parallel in the manner described above are recorded in Table 3. The propylene oxide-producing catalysts were identified from the data and the yield was correlated by means of the sample name with the catalyst composition calculated from the preparation data. (See Table 4 below.) It was thus shown that the efficiency of catalysts for a special reaction in a parallel reactor of the type described may be determined automatically with the process described and assessed on a comparative basis within a short time.

TABLE I
List of sol-gel precursor compounds used

| | | | | | | | | Property 2 |
|---|---|---|---|---|---|---|---|---|
| | | | | | | | | Concentration |
| | | | | Molecular | | Unit for | Property 1 | Millimole per |
| No. | Name of substance | CAS Reg. no. | Role | weight | Amount | amount | Symbol | milliliter |
| 1 | Tetraethoxysilane/methyltri- | | Support | 190.3 | 10 | Millimole | Si | 4.84 |
| | Methoxy- | | | | | | | |
| | Silane 3:1 | | | | | | | |
| 2 | Ethanol | | Solvent | 46.07 | | | | |
| 3 | Molybdenum chloride | 10241-05-01 | Precursor | 273.21 | 1 | Millimole | Mo | 1 |
| 4 | Cobalt(II) chloride-6-hydrate | | Precursor | 237.93 | 1 | Millimole | Co | 1 |
| 5 | Copper(II) nitrate trihydrate | | Precursor | 241.6 | 1 | Millimole | Cu | 1 |
| 6 | Tungsten(VI) chloride | 12382-01-7 | Precursor | 396.57 | 1 | Millimole | W | 1 |
| 7 | Iron(III) nitrate*9H2O | 7782-61-8 | Precursor | 404 | 1 | Millimole | Fe | 0.75 |
| 8 | Chromium(III) chloride-6- | 10060-12-5 | Precursor | 266.45 | 1 | Millimole | Cr | 1 |
| | hydrate | | | | | | | |
| 9 | Vanadium(III) chloride | | Precursor | 157.3 | 1 | Millimole | V | 1 |
| 10 | Tetraisopropylorthotitanate | 546-68-9 | Precursor | 284.26 | 1 | Millimole | Ti | 1 |
| 11 | Antimony(V) chloride | | Precursor | 299.02 | 1 | Millimole | Sb | 1 |
| 12 | Manganese(II) acetate-4- | | Precursor | 245.09 | 1 | Millimole | Mn | 1 |
| | hydrate | | | | | | | |
| 13 | Bismuth(II)-ethylhexanoate | 67874-71-9 | Precursor | 638.61 | 1 | Millimole | Bi | 1 |
| 14 | Silver nitrate | | Precursor | 169.87 | 1 | Millimole | Ag | 1 |
| 15 | Nitric acid | | Catalyst | 63.01 | | | | |
| 16 | Water | | Reactant | 18 | | | | |

TABLE 2
Process for catalyst preparation

| | | | | Property 1 | | | | |
|---|---|---|---|---|---|---|---|---|
| | | Step no. | | Calcining | Property 2 | Property 3 | | |
| | | Property | | temper- | Calcining | Calcining | | Property 5 |
| | | Description | Additional | ature deg. | time | atmosphere | | Total volume |
| Item | No. | ID for batch | matrix ID | Celsius | hours | name | Ratio of elements | microliters |
| A1 | 1 | DGL102301 | 6 | 220 | 4 | Air | Si1Mo0.0159Fe0.015Cr0.0159 | 1437 |
| | | | | | | | V0.0159Ti0.0159Sb0.0159Mn0.0159 | |
| A2 | 1 | DGL102302 | 6 | 220 | 4 | Air | Si1Mo0.0139Fe0.0139Cr0.0139 | 1432 |
| | | | | | | | V0.0139Ti0.0139Sb0.0139Mn0.0139Ag0.0139 | |
| A3 | 1 | DGL102303 | 6 | 220 | 4 | Air | Si1Mo0.0139Fe0.0139Cr0.0139 | 1432 |
| | | | | | | | V0.0139Ti0.0139Sb0.0139Mn0.0139Bi0.0139 | |
| A4 | 1 | DGL102304 | 6 | 220 | 4 | Air | Si1Mo0.0124Fe0.0124Cr0.0124V0.0124 | 1434 |
| | | | | | | | Ti0.0124Sb0.0124Mn0.0124Bi0.0124Ag0.0124 | |
| A5 | 1 | DGL102305 | 6 | 220 | 4 | Air | Si1Mo0.0556W0.0556 | 1423 |
| A6 | 1 | DGL102306 | 6 | 220 | 4 | Air | Si1Mo0.037W0.037Ag0.037 | 1422 |
| A7 | 1 | DGL102307 | 6 | 220 | 4 | Air | Si1Mo0.037W0.037Bi0.037 | 1422 |
| A8 | 1 | DGL102308 | 6 | 220 | 4 | Air | Si1Mo0.0278W0.0278Bi0.0278Ag0.0278 | 1425 |
| A9 | 1 | DGL102309 | 6 | 220 | 4 | Air | Si1Mo0.037W0.037Mn0.037 | 1422 |
| A10 | 1 | DGL102310 | 6 | 220 | 4 | Air | Si1Mo0.0278W0.0278Mn0.0278Ag0.0278 | 1425 |
| B1 | 1 | DGL102311 | 6 | 220 | 4 | Air | Si1Mo0.0278W0.0278Mn0.0278Bi0.0278 | 1425 |
| B2 | 1 | DGL102312 | 6 | 220 | 4 | Air | Si1Mo0.0222W0.0222Mn0.0222Bi0.0222 | 1423 |
| | | | | | | | Ag0.0222 | |
| B3 | 1 | DGL102313 | 6 | 220 | 4 | Air | Si1Mo0.037W0.037Sb0.037 | 1422 |
| B4 | 1 | DGL102314 | 6 | 220 | 4 | Air | Si1Mo0.0278W0.0278Sb0.0278Ag0.0278 | 1425 |
| B5 | 1 | DGL102315 | 6 | 220 | 4 | Air | Si1Mo0.0278W0.0278Sb0.0278Bi0.0278 | 1425 |
| B6 | 1 | DGL102316 | 6 | 220 | 4 | Air | Si1Mo0.0222W0.0222Sb0.0222Bi0.0222 | 1423 |
| | | | | | | | Ag0.0222 | |
| B7 | 1 | DGL102317 | 6 | 220 | 4 | Air | Si1Mo0.0278W0.0278Sb0.0278Mn0.0278 | 1425 |
| B8 | 1 | DGL102318 | 6 | 220 | 4 | Air | Si1Mo0.0222W0.0222Sb0.0222Mn0.0222 | 1423 |
| | | | | | | | Ag0.0222 | |
| B9 | 1 | DGL102319 | 6 | 220 | 4 | Air | Si1Mo0.0222W0.0222Sb0.0222Mn0.0222 | 1423 |
| | | | | | | | Bi0.0222 | |
| B10 | 1 | DGL102320 | 6 | 220 | 4 | Air | Si1Mo0.0185W0.0185Sb0.0185Mn0.0185 | 1425 |
| | | | | | | | Bi0.0185Ag0.0185 | |
| C1 | 1 | DGL102321 | 6 | 220 | 4 | Air | Si1Mo0.037W0.037Ti0.037 | 1422 |
| C2 | 1 | DGL102322 | 6 | 220 | 4 | Air | Si1Mo0.0278W0.0278Ti0.0278Ag0.0278 | 1425 |
| C3 | 1 | DGL102323 | 6 | 220 | 4 | Air | Si1Mo0.0278W0.0278Ti0.0278Bi0.0278 | 1425 |
| C4 | 1 | DGL102324 | 6 | 220 | 4 | Air | Si1Mo0.0222W0.0222Ti0.0222Bi0.0222Ag0.0222 | 1423 |
| C5 | 1 | DGL102325 | 6 | 220 | 4 | Air | Si1Mo0.0278W0.0278Ti0.0278Mn0.0278 | 1425 |
| C6 | 1 | DGL102326 | 6 | 220 | 4 | Air | Si1Mo0.0222W0.0222Ti0.0222Mn0.0222Ag0.0222 | 1423 |
| C7 | 1 | DGL102327 | 6 | 220 | 4 | Air | Si1Mo0.02222W0.0222Ti0.0222Mn0.0222 | 1423 |
| | | | | | | | Bi0.0222 | |
| C8 | 1 | DGL102328 | 6 | 220 | 4 | Air | Si1Mo0.0185W0.0185Ti0.0185Mn0.0185 | 1425 |
| | | | | | | | Bi0.0185Ag0.0185 | |
| C9 | 1 | DGL102329 | 6 | 220 | 4 | Air | Si1Mo0.0278W0.0278Ti0.0278Sb0.0278 | 1425 |
| C10 | 1 | DGL102330 | 6 | 220 | 4 | Air | Si1Mo0.0222W0.0222Ti0.0222Sb0.0222 | 1423 |
| | | | | | | | Ag0.0222 | |
| D1 | 1 | DGL102331 | 6 | 220 | 4 | Air | Si1Mo0.0222W0.0222Ti0.0222Sb0.0222 | 1423 |
| | | | | | | | Bi0.0222 | |
| D2 | 1 | DGL102332 | 6 | 220 | 4 | Air | Si1Mo0.0185W0.0185Ti0.0185Sb0.0185 | 1425 |
| | | | | | | | Bi0.0185Ag0.0185 | |
| D3 | 1 | DGL102333 | 6 | 220 | 4 | Air | Si1Mo0.0222W0.0222Ti0.0222 | 1423 |
| | | | | | | | Sb0.0222Mn0.0222 | |
| D4 | 1 | DGL102334 | 6 | 220 | 4 | Air | Si1Mo0.0185W0.0185Ti0.0185Sb0.0185 | 1425 |
| | | | | | | | Mn0.0185Ag0.0185 | |
| D5 | 1 | DGL102335 | 6 | 220 | 4 | Air | Si1Mo0.0185W0.0185Ti0.0185Sb0.0185 | 1425 |
| | | | | | | | Mn0.0185Bi0.0185 | |
| D6 | 1 | DGL102336 | 6 | 220 | 4 | Air | Si1Mo0.0159W0.0159Ti0.0159Sb0.0159 | 1425 |
| | | | | | | | Mn0.0159Bi0.0159Ag0.0159 | |
| D7 | 1 | DGL102337 | 6 | 220 | 4 | Air | Si1Mo0.037W0.037V0.037 | 1422 |
| D8 | 1 | DGL102338 | 6 | 220 | 4 | Air | Si1Mo0.0278W0.0278V0.0278Ag0.0278 | 1425 |
| D9 | 1 | DGL102339 | 6 | 220 | 4 | Air | Si1Mo0.0278W0.0278V0.0278Bi0.0278 | 1425 |
| D10 | 1 | DGL102340 | 6 | 220 | 4 | Air | Si1Mo0.0222W0.0222V0.0222Bi0.0222 | 1423 |
| | | | | | | | Ag0.0222 | |
| E1 | 1 | DGL102341 | 6 | 220 | 4 | Air | Si1Mo0.0278W0.0278V0.0278Mn0.0278 | 1425 |
| E2 | 1 | DGL102342 | 6 | 220 | 4 | Air | Si1Mo0.0.0222W0.0222V0.0222Mn0.0222 | 1423 |
| | | | | | | | Ag0.0222 | |
| E3 | 1 | DGL102343 | 6 | 220 | 4 | Air | Si1Mo0.0222W0.0222V0.0222Mn0.0222 | 1423 |
| | | | | | | | Bi0.0222 | |
| E4 | 1 | DGL102344 | 6 | 220 | 4 | Air | Si1Mo0.0185W0.0185V0.0185Mn0.0185 | 1425 |
| | | | | | | | Bi0.0185Ag0.0185 | |
| E5 | 1 | DGL102345 | 6 | 220 | 4 | Air | Si1Mo0.0278W0.0278V0.0278Sb0.0278 | 1425 |
| E6 | 1 | DGL102346 | 6 | 220 | 4 | Air | Si1Mo0.0222W0.0222V0.0222Sb0.0222 | 1423 |
| | | | | | | | Ag0.0222 | |
| E7 | 1 | DGL102347 | 6 | 220 | 4 | Air | Si1Mo0.0222W0.0222V0.0222Sb0.0222 | 1423 |
| | | | | | | | Bi0.0222 | |
| E8 | 1 | DGL102348 | 6 | 220 | 4 | Air | Si1Mo0.0185W0.0185V0.0185Sb0.0185 | 1425 |
| | | | | | | | Bi0.0185Ag0.0185 | |
| E9 | 1 | DGL102349 | 6 | 220 | 4 | Air | Si1Mo0.0222W0.0222V0.0222Sb0.0222 | 1423 |
| | | | | | | | Mn0.0222 | |
| E10 | 1 | DGL102350 | 6 | 220 | 4 | Air | Si1Mo0.0185W0.0185V0.0185Sb0.0185 | 1425 |
| | | | | | | | Mn0.0185Ag0.0185 | |
| F1 | 1 | DGL102351 | 6 | 220 | 4 | Air | Mo0.0185W0.0185V0.0185Sb0.0185 | 1425 |
| | | | | | | | Mn0.0185Bi0.0185 | |
| F2 | 1 | DGL102352 | 6 | 220 | 4 | Air | Si1Mo0.0159W0.0159V0.0159Sb0.0159 | 1425 |
| | | | | | | | Mn0.0159Bi0.0159Ag0.0159 | |
| F3 | 1 | DGL102353 | 6 | 220 | 4 | Air | Si1Mo0.0278W0.0278V0.0278Ti0.0278 | 1425 |
| F4 | 1 | DGL102354 | 6 | 220 | 4 | Air | Si1Mo0.0222W0.0222V0.0222Ti0.0222 | 1423 |
| | | | | | | | Ag0.0222 | |
| F5 | 1 | DGL102355 | 6 | 220 | 4 | Air | Si1Mo0.0222W0.0222V0.0222Ti0.0222 | 1423 |
| | | | | | | | Bi0.0222 | |
| F6 | 1 | DGL102356 | 6 | 220 | 4 | Air | Si1Mo0.0185W0.0185V0.0185Ti0.0185 | 1425 |
| | | | | | | | Bi0.0185Ag0.0185 | |
| F7 | 1 | DGL102357 | 6 | 220 | 4 | Air | Si1Mo0.0222W0.0222V0.0222Ti0.0222 | 1423 |
| | | | | | | | Mn0.0222 | |
| F8 | 1 | DGL102358 | 6 | 220 | 4 | Air | Si1Mo0.0185W0.0185V0.0185Ti0.0185 | 1425 |
| | | | | | | | Mn0.0185Ag0.0185 | |
| F9 | 1 | DGL102359 | 6 | 220 | 4 | Air | Si1Mo0.0185W0.0185V0.0185Ti0.0185 | 1425 |
| | | | | | | | Mn0.0185Bi0.0185 | |
| F10 | 1 | DGL102360 | 6 | 220 | 4 | Air | Si1Mo0.0159W0.0159V0.0159Ti0.0159 | 1425 |
| | | | | | | | Mn0.0159Bi0.0159Ag0.0159 | |
| G1 | 1 | DGL102361 | 6 | 220 | 4 | Air | Si1Mo0.0222W0.0222V0.0222Ti0.0222 | 1423 |
| | | | | | | | Sb0.0222 | |
| G2 | 1 | DGL102362 | 6 | 220 | 4 | Air | Si1Mo0.0185W0.0185V0.0185Ti0.0185 | 1425 |
| | | | | | | | Sb0.0185Ag.0185 | |
| G3 | 1 | DGL102363 | 6 | 220 | 4 | Air | Si1Mo0.0185W0.0185V0.0185Ti0.0185 | 1425 |
| | | | | | | | Sb0.0185Bi0.0185 | |
| G4 | 1 | DGL102364 | 6 | 220 | 4 | Air | Si1Mo0.0159W0.0159V0.0159Ti0.0159 | 1425 |
| | | | | | | | Sb0.0159Bi0.0159Ag0.0159 | |
| G5 | 1 | DGL102365 | 6 | 220 | 4 | Air | Si1Mo0.0185W0.0185V0.0185Ti0.0185 | 1425 |
| | | | | | | | Sb0.0185Mn0.0185 | |
| G6 | 1 | DGL102366 | 6 | 220 | 4 | Air | Si1Mo0.0159W0.0159V0.0159Ti0.0159 | 1425 |
| | | | | | | | Sb0.0159Mn0.0159Ag0.0159 | |
| G7 | 1 | DGL102367 | 6 | 220 | 4 | Air | Si1Mo0.0159W0.0159V0.0159Ti0.0159 | 1425 |
| | | | | | | | Sb0.0159Mn0.0159Bi0.0159 | |
| G8 | 1 | DGL102368 | 6 | 220 | 4 | Air | Si1Mo0.0139W0.0139V0.0139Ti0.0139 | 1421 |
| | | | | | | | Sb0.0139mMn0.0139Bi0.0139Ag0.0139 | |
| G9 | 1 | DGL102369 | 6 | 220 | 4 | Air | Si1Mo0.037W0.037Cr0.037 | 1422 |
| G10 | 1 | DGLI02370 | 6 | 220 | 4 | Air | Si1Mo0.0278W0.0278Cr0.0278Ag0.0278 | 1425 |
| H1 | 1 | DGL102371 | 6 | 220 | 4 | Air | Si1Mo0.0278W0.0278Cr0.0278Bi0.0278 | 1425 |
| H2 | 1 | DGL102372 | 6 | 220 | 4 | Air | Si1Mo0.0222W0.0222Cr0.0222Bi0.0222 | 1423 |
| | | | | | | | Ag0.0222 | |
| H3 | 1 | DGL102373 | 6 | 220 | 4 | Air | Si1Mo0.0278W0.0278Cr0.0278Mn0.0278 | 1425 |
| H4 | 1 | DGL102374 | 6 | 220 | 4 | Air | Si1Mo0.0222W0.0222Cr0.0222Mn0.0222 | 1423 |
| | | | | | | | Ag0.0222 | |
| H5 | 1 | DGL102375 | 6 | 220 | 4 | Air | Si1Mo0.0222W0.0222Cr0.0222Mn0.0222 | 1423 |
| | | | | | | | Bi0.0222 | |
| H6 | 1 | DGL102376 | 6 | 220 | 4 | Air | Si1Mo0.0185W0.0185Cr0.0185Mn0.0185 | 1425 |
| | | | | | | | Bi0.0185Ag0.0185 | |
| H7 | 1 | DGL102377 | 6 | 220 | 4 | Air | Si1Mo0.0278W0.0278Cr0.0278Sb0.0278 | 1425 |
| H8 | 1 | DGL102378 | 6 | 220 | 4 | Air | Si1Mo0.0222W0.0222Cr0.0222Sb0.0222 | 1423 |
| | | | | | | | Ag0.0222 | |
| H9 | 1 | DGL102379 | 6 | 220 | 4 | Air | Si1Mo0.0222W0.0222Cr0.0222Sb0.0222 | 1423 |
| | | | | | | | Bi0.0222 | |
| H10 | 1 | DGL102380 | 6 | 220 | 4 | Air | Si1Mo0.0185W0.0185Cr0.0185Sb0.0185 | 1425 |
| | | | | | | | Bi0.0185 Ag0.0185 | |
| I1 | 1 | DGL102381 | 6 | 220 | 4 | Air | Si1Mo0.0222W0.0222Cr0.0222Sb0.0222 | 1423 |
| | | | | | | | Mn0.0222 | |
| I2 | 1 | DGL102382 | 6 | 220 | 4 | Air | Si1Mo0.0185W0.0185Cr0.0185Sb0.0185 | 1425 |
| | | | | | | | Mn0.0185Ag0.0185 | |
| I3 | 1 | DGL102383 | 6 | 220 | 4 | Air | Si1Mo0.0185W0.0185Cr0.0185Sb0.0185 | 1425 |
| | | | | | | | Mn0.0185Bi0.0185 | |
| I4 | 1 | DGL102384 | 6 | 220 | 4 | Air | Si1Mo0.0159W0.0159Cr0.0159Sb0.0159 | 1425 |
| | | | | | | | Mn0.0159Bi0.0159Ag0.0159 | |
| I5 | 1 | DGL102385 | 6 | 220 | 4 | Air | Si1Mo0.0278W0.0278Cr0.0278Ti0.0278 | 1425 |
| I6 | 1 | DGL102386 | 6 | 220 | 4 | Air | Si1Mo0.0222W0.0222Cr0.0222Ti0.0222 | 1423 |
| | | | | | | | Ag0.0222 | |
| I7 | 1 | DGL102387 | 6 | 220 | 4 | Air | Si1Mo0.0222W0.0222Cr0.0222Ti0.0222 | 1423 |
| | | | | | | | Bi0.0222 | |
| I8 | 1 | DGL102388 | 6 | 220 | 4 | Air | Si1Mo0.0185W0.0185Cr0.0185Ti0.0185 | 1425 |
| | | | | | | | Bi0.0185Ag0.0185 | |
| I9 | 1 | DGL102389 | 6 | 220 | 4 | Air | Si1Mo0.0222W0.0222Cr0.0222Ti0.0222 | 1423 |
| | | | | | | | Mn0.0222 | |
| I10 | 1 | DGL102390 | 6 | 220 | 4 | Air | Si1Mo0.0185W0.0185Cr0.0185Ti0.0185 | 1425 |
| | | | | | | | Mn0.0185Ag0.0185 | |
| J1 | 1 | DGL102391 | 6 | 220 | 4 | Air | Si1Mo0.0185W0.0185Cr0.0185Ti0.0185 | 1425 |
| | | | | | | | Mn0.0185Bi0.0185 | |
| J2 | 1 | DGL102392 | 6 | 220 | 4 | Air | Si1Ml0.0159W0.0159Cr0.0159Ti0.0159 | 1425 |
| | | | | | | | Mn0.0159Bi0.0159Ag0.0159 | |
| J3 | 1 | DGL102393 | 6 | 220 | 4 | Air | Si1Mo0.0222W0.0222Cr0.0222Ti0.0222 | 1423 |
| | | | | | | | Sb0.0222 | |
| J4 | 1 | DGL102394 | 6 | 220 | 4 | Air | Si1Mo0.0185W0.0185Cr0.0185Ti0.0185 | 1425 |
| | | | | | | | Sb0.0185Ag0.0185 | |
| J5 | 1 | DGL102395 | 6 | 220 | 4 | Air | Si1Mo0.0185W0.0185Cr0.0185Ti0.0185 | 1425 |
| | | | | | | | Sb0.0185Bi0.0185 | |
| J6 | 1 | DGL102396 | 6 | 220 | 4 | Air | Si1Mo0.0159W0.0159Cr0.0159Ti0.0159 | 1425 |
| | | | | | | | Sb0.0159Bi0.0159Ag0.0159 | |
| J7 | 1 | DGL102397 | 6 | 220 | 4 | Air | Si1Mo0.0185W0.0185Cr0.0185Ti0.0185 | 1425 |
| | | | | | | | Sb0.0185Mn0.0185 | |
| J8 | 1 | DGL102398 | 6 | 220 | 4 | Air | Si1Mo0.0159W0.0159Cr0.0159Ti0.0159 | 1425 |
| | | | | | | | Sb0.0159Mn0.0159Ag0.0159 | |
| J9 | 1 | DGL102399 | 6 | 220 | 4 | Air | Si1Mo0.0159W0.0159Cr0.0159Ti0.0159 | 1425 |
| | | | | | | | Sb0.0159Mn0.0159Bi0.0159 | |
| J10 | 1 | DGL102400 | 6 | 220 | 4 | Air | Si1Mo0.0139W0.0139Cr0.0139Ti0.0139 | 1421 |
| | | | | | | | Sb0.0139 | |
| | | | | | | | Mn0.0139Bi0.0139Ag0.0139 | |

TABLE 3
Test data from catalyst parallel analysis

| | | | | Ace- | | |
|---|---|---|---|---|---|---|
| | | | | talde- | Sum: | |
| | | Pro- | | hyde | acetone/ | |
| | | pylene | Propene | [GC | propionald. | Propylene |
| | | oxide | [GC peak | peak | [GC peak | oxide [GC |
| | | yield | area | area | area | peak area |
| Test no. | Cycle | [%] | in %] | n %] | in %] | in %] |
| DGL 102300 | 3 | 00 | 99.835636 | 0 | 0.052153 | 0 |
| DGL 102300 | 4 | 0 | 99.839507 | 0 | 0.049443 | 0 |
| DGL 102301 | 3 | 0 | 99.914578 | 0 | 0.019736 | 0 |
| DGL 102301 | 4 | 0 | 99.920671 | 0 | 0.018378 | 0 |
| DGL 102302 | 3 | 0 | 99.911774 | 0 | 0.030209 | 0 |
| DGL 102302 | 4 | 0 | 99.921665 | 0 | 0.026972 | 0 |
| DGL 102303 | 3 | 0 | 99.921241 | 0 | 0.021005 | 0 |
| DGL 102303 | 4 | 0 | 99.930118 | 0 | 0.015399 | 0 |
| DGL 102304 | 3 | 0 | 99.920267 | 0 | 0.027079 | 0 |
| DGL 102304 | 4 | 0 | 99.930556 | 0 | 0.019074 | 0 |
| DGL 102305 | 3 | 0 | 99.898145 | 0 | 0.060659 | 0 |
| DGL 102305 | 4 | 0 | 99.903597 | 0 | 0.05558 | 0 |
| DGL 102306 | 3 | 0 | 99.850802 | 0 | 0.112629 | 0 |
| DGL 102306 | 4 | 0 | 99.87507 | 0 | 0.091554 | 0 |
| DGL 102307 | 3 | 0 | 99.897003 | 0 | 0.038056 | 0 |
| DGL 102307 | 4 | 0 | 99.903958 | 0 | 0.030888 | 0 |
| DGL 102308 | 3 | 0 | 99.880945 | 0 | 0.074359 | 0 |
| DGL 102308 | 4 | 0 | 99.886444 | 0 | 0.067033 | 0 |
| DGL 102309 | 3 | 0 | 99.923925 | 0 | 0.025384 | 0 |
| DGL 102309 | 4 | 0 | 99.931565 | 0 | 0.020234 | 0 |
| DGL 102310 | 3 | 0 | 99.927508 | 0 | 0.029526 | 0 |
| DGL 102310 | 4 | 0 | 99.935129 | 0 | 0.026475 | 0 |
| DGL 102311 | 3 | 0 | 99.888501 | 0 | 0.052271 | 0 |
| DGL 102311 | 4 | 0 | 99.898863 | 0 | 0.049892 | 0 |
| DGL 102312 | 3 | 0.011625 | 99.882301 | 0 | 0.005069 | 0.011611 |
| DGL 102312 | 4 | 0 | 99.885768 | 0 | 0.015792 | 0 |
| DGL 102313 | 3 | 0 | 99.916098 | 0 | 0.047091 | 0 |
| DGL 102313 | 4 | 0 | 99.920173 | 0 | 0.048269 | 0 |
| DGL 102314 | 3 | 0 | 99.88487 | 0 | 0.037508 | 0 |
| DGL 102314 | 4 | 0 | 99.894936 | 0 | 0.030829 | 0 |
| DGL 102315 | 3 | 0 | 99.90302 | 0 | 0.049239 | 0 |
| DGL 102315 | 4 | 0 | 99.912944 | 0 | 0.0485 | 0 |
| DGL 102316 | 3 | 0 | 99.868381 | 0 | 0.038996 | 0 |
| DGL 102316 | 4 | 0 | 99.884016 | 0 | 0.026463 | 0 |
| DGL 102317 | 3 | 0 | 99.918297 | 0 | 0.03748 | 0 |
| DGL 102317 | 4 | 0 | 99.926359 | 0 | 0.038566 | 0 |
| DGL 102318 | 3 | 0 | 99.906351 | 0 | 0.011734 | 0 |
| DGL 102318 | 4 | 0 | 99.911818 | 0 | 0.009849 | 0 |
| DGL 102319 | 3 | 0 | 99.914955 | 0 | 0.031108 | 0 |
| DGL 102319 | 4 | 0 | 99.921367 | 0 | 0.02639 | 0 |
| DGL 102320 | 3 | 0 | 99.87714 | 0 | 0.02047 | 0 |
| DGL 102320 | 4 | 0.017345 | 99.885604 | 0 | 0.00302 | 0.017325 |
| DGL 102321 | 3 | 0 | 99.876691 | 0 | 0.081792 | 0 |
| DGL 102321 | 4 | 0 | 99.87591 | 0 | 0.082996 | 0 |
| DGL 102322 | 3 | 0 | 99.883691 | 0 | 0.08748 | 0 |
| DGL 102322 | 4 | 0 | 99.889782 | 0 | 0.075962 | 0 |
| DGL 102323 | 3 | 0 | 99.891146 | 0 | 0.058811 | 0 |
| DGL 102323 | 4 | 0 | 99.891624 | 0 | 0.060054 | 0 |
| DGL 102324 | 3 | 0 | 99.879662 | 0 | 0.0751560. | 0 |
| DGL 102324 | 4 | 0 | 99.891691 | 0 | 06533 | 0 |
| DGL 102325 | 3 | 0 | 99.929792 | 0 | 0.021464 | 0 |
| DGL 102325 | 4 | 0 | 99.931819 | 0 | 0.020114 | 0 |
| DGL 102326 | 3 | 0 | 99.919787 | 0 | 0.037724 | 0 |
| DGL 102326 | 4 | 0 | 99.93702 | 0 | 0.030119 | 0 |
| DGL 102327 | 3 | 0 | 99.907246 | 0 | 0.040683 | 0 |
| DGL 102327 | 4 | 0 | 99.907532 | 0 | 0.04194 | 0 |
| DGL 102328 | 3 | 0 | 99.892757 | 0 | 0.060145 | 0 |
| DGL 102328 | 4 | 0 | 99.894928 | 0 | 0.059145 | 0 |
| DGL 102329 | 3 | 0 | 99.892715 | 0 | 0.057386 | 0 |
| DGL 102329 | 4 | 0 | 99.897342 | 0 | 0.053768 | 0 |
| DGL 102330 | 3 | 0 | 99.870327 | 0 | 0.077464 | 0 |
| DGL 102330 | 4 | 0 | 99.884438 | 0 | 0.068307 | 0 |
| DGL 102331 | 3 | 0 | 99.902319 | 0 | 0.043975 | 0 |
| DGL 102331 | 4 | 0 | 99.914745 | 0 | 0.039675 | 0 |
| DGL 102332 | 3 | 0 | 99.866535 | 0 | 0.046176 | 0 |
| DGL 102332 | 4 | 0 | 99.86718 | 0 | 0.047689 | 0 |
| DGL 102333 | 3 | 0 | 99.918851 | 0 | 0.046546 | 0 |
| DGL 102333 | 4 | 0 | 99.91267 | 0 | 0.021424 | 0 |
| DGL 102334 | 3 | 0 | 99.909771 | 0 | 0.013735 | 0 |
| DGL 102334 | 4 | 0 | 99.907451 | 0 | 0.018132 | 0 |
| DGL 102335 | 3 | 0 | 99.924226 | 0 | 0.03412 | 0 |
| DGL 102335 | 4 | 0 | 99.926493 | 0 | 0.03531 | 0 |
| DGL 102336 | 3 | 0 | 99.88043 | 0 | 0.032791 | 0 |
| DGL 102336 | 4 | 0 | 99.885941 | 0 | 0.028607 | 0 |
| DGL 102337 | 3 | 0 | 99.936629 | 0 | 0.039241 | 0 |
| DGL 102337 | 4 | 0 | 99.9416 | 0 | 0.016347 | 0 |
| DGL 102338 | 3 | 0 | 99.807905 | 0 | 0.122649 | 0 |
| DGL 102338 | 4 | 0 | 99.835382 | 0 | 0.097879 | 0 |
| DGL 102339 | 3 | 0 | 99.869243 | 0 | 0.0868 | 0 |
| DGL 102339 | 4 | 0 | 99.880733 | 0 | 0.075105 | 0 |
| DGL 102340 | 3 | 0 | 99.836405 | 0 | 0.072959 | 0 |
| DGL 102340 | 4 | 0 | 99.844555 | 0 | 0.042245 | 0 |
| DGL 102341 | 3 | 0 | 99.910825 | 0 | 0.035462 | 0 |
| DGL 102341 | 4 | 0 | 99.91508 | 0 | 0.032493 | 0 |
| DGL 102342 | 3 | 0 | 99.918752 | 0 | 0.039071 | 0 |
| DGL 102342 | 4 | 0 | 99.928274 | 0 | 0.035163 | 0 |
| DGL 102343 | 3 | 0 | 99.905882 | 0 | 0.042464 | 0 |
| DGL 102343 | 4 | 0 | 99.911007 | 0 | 0.040549 | 0 |
| DGL 102344 | 3 | 0 | 99.908028 | 0 | 0.046136 | 0 |
| DGL 102344 | 4 | 0 | 99.912025 | 0 | 0.047738 | 0 |
| DGL 102345 | 3 | 0 | 99.892143 | 0 | 0.061815 | 0 |
| DGL 102345 | 4 | 0 | 99.903009 | 0 | 0.055957 | 0 |
| DGL 102346 | 3 | 0 | 99.892823 | 0 | 0.066489 | 0 |
| DGL 102346 | 4 | 0 | 99.912112 | 0 | 0.054285 | 0 |
| DGL 102347 | 3 | 0 | 99.900865 | 0 | 0.048079 | 0 |
| DGL 102347 | 4 | 0 | 99.903459 | 0 | 0.046396 | 0 |
| DGL 102348 | 3 | 0 | 99.8791 | 0 | 0.073843 | 0 |
| DGL 102348 | 4 | 0 | 99.888639 | 0 | 0.06514 | 0 |
| DGL 102349 | 3 | 0 | 99.923234 | 0 | 0.022714 | 0 |
| DGL 102349 | 4 | 0 | 99.923311 | 0 | 0.02476 | 0 |
| DGL 102350 | 3 | 0 | 99.908267 | 0 | 0.043557 | 0 |
| DGL 102350 | 4 | 0 | 99.915978 | 0 | 0.041646 | 0 |
| DGL 102351 | 3 | 0 | 99.861916 | 0 | 0.090544 | 0 |
| DGL 102351 | 4 | 0 | 99.87966 | 0 | 0.07821 | 0 |
| DGL 102352 | 3 | 0 | 99.877899 | 0 | 0.024068 | 0 |
| DGL 102352 | 4 | 0 | 99.880311 | 0 | 0.025505 | 0 |
| DGL 102353 | 3 | 0 | 99.895588 | 0 | 0.076359 | 0 |
| DGL 102353 | 4 | 0 | 99.914909 | 0 | 0.062258 | 0 |
| DGL 102354 | 3 | 0 | 99.87752 | 0 | 0.050519 | 0 |
| DGL 102354 | 4 | 0 | 99.882374 | 0 | 0.046588 | 0 |
| DGL 102355 | 3 | 0 | 99.902417 | 0 | 0.070352 | 0 |
| DGL 102355 | 4 | 0 | 99.9164 | 0 | 0.056616 | 0 |
| DGL 102356 | 3 | 0 | 99.872398 | 0 | 0.044832 | 0 |
| DGL 102356 | 4 | 0 | 99.885248 | 0 | 0.03518 | 0 |
| DGL 102357 | 3 | 0 | 99.913684 | 0 | 0.051313 | 0 |
| DGL 102357 | 4 | 0 | 99.923796 | 0 | 0.044127 | 0 |
| DGL 102358 | 3 | 0 | 99.898695 | 0 | 0.018683 | 0 |
| DGL 102358 | 4 | 0 | 99.905427 | 0 | 0.018373 | 0 |
| DGL 102359 | 3 | 0 | 99.923877 | 0 | 0.040648 | 0 |
| DGL 102359 | 4 | 0 | 99.929591 | 0 | 0.038427 | 0 |
| DGL 102360 | 3 | 0 | 99.848552 | 0 | 0.057824 | 0 |
| DGL 102360 | 4 | 0 | 99.871118 | 0 | 0.046142 | 0 |
| DGL 102361 | 3 | 0 | 99.87829 | 0 | 0.066871 | 0 |
| DGL 102361 | 4 | 0 | 99.88219 | 0 | 0.064799 | 0 |
| DGL 102362 | 3 | 0 | 99.884294 | 0 | 0.070829 | 0 |
| DGL 102362 | 4 | 0 | 99.893268 | 0 | 0.061625 | 0 |
| DGL 102363 | 3 | 0 | 99.905106 | 0 | 0.044235 | 0 |
| DGL 102363 | 4 | 0 | 99.903689 | 0 | 0.046033 | 0 |
| DGL 102364 | 3 | 0 | 99.901247 | 0 | 0.052861 | 0 |
| DGL 102364 | 4 | 0 | 99.903986 | 0 | 0.050058 | 0 |
| DGL 102365 | 3 | 0 | 99.936024 | 0 | 0.013456 | 0 |
| DGL 102365 | 4 | 0 | 99.938117 | 0 | 0.012473 | 0 |
| DGL 102366 | 3 | 0 | 99.926781 | 0 | 0.026803 | 0 |
| DGL 102366 | 4 | 0 | 99.933153 | 0 | 0.02293 | 0 |
| DGL 102367 | 3 | 0 | 99.918472 | 0 | 0.031045 | 0 |
| DGL 102367 | 4 | 0 | 99.923492 | 0 | 0.023188 | 0 |
| DGL 102368 | 3 | 0 | 99.904769 | 0 | 0.043056 | 0 |
| DGL 102368 | 4 | 0 | 99.913021 | 0 | 0.039678 | 0 |
| DGL 102369 | 3 | 0 | 99.886802 | 0 | 0.065078 | 0 |
| DGL 102369 | 4 | 0 | 99.900889 | 0 | 0.053736 | 0 |
| DGL 102370 | 3 | 0 | 99.885347 | 0 | 0.079336 | 0 |
| DGL 102370 | 4 | 0 | 99.912572 | 0 | 0.059582 | 0 |
| DGL 102371 | 3 | 0 | 99.902123 | 0 | 0.047673 | 0 |
| DGL 102371 | 4 | 0 | 99.897495 | 0 | 0.048208 | 0 |
| DGL 102372 | 3 | 0 | 99.879505 | 0 | 0.039371 | 0 |
| DGL 102372 | 4 | 0 | 99.881852 | 0 | 0.034796 | 0 |
| DGL 102373 | 3 | 0 | 99.922853 | 0 | 0.046408 | 0 |
| DGL 102373 | 4 | 0 | 99.915649 | 0 | 0.04809 | 0 |
| DGL 102374 | 3 | 0 | 99.908106 | 0 | 0.016869 | 0 |
| DGL 102374 | 4 | 0 | 99.914201 | 0 | 0.013325 | 0 |
| DGL 102375 | 3 | 0 | 99.935142 | 0 | 0.038103 | 0 |
| DGL 102375 | 4 | 0 | 99.935361 | 0 | 0.035601 | 0 |
| DGL 102376 | 3 | 0 | 99.902325 | 0 | 0.017802 | 0 |
| DGL 102376 | 4 | 0.007556 | 99.909125 | 0 | 0.008645 | 0.007549 |
| DGL 102377 | 3 | 0 | 99.93209 | 0 | 0.032118 | 0 |
| DGL 102377 | 4 | 0 | 99.93169 | 0 | 0.031501 | 0 |
| DGL 102378 | 3 | 0 | 99.874848 | 0 | 0.04202 | 0 |
| DGL 102378 | 4 | 0 | 99.883049 | 0 | 0.036418 | 0 |
| DGL 102379 | 3 | 0 | 99.90903 | 0 | 0.03211 | 0 |
| DGL 102379 | 4 | 0 | 99.930907 | 0 | 0.021882 | 0 |
| DGL 102380 | 3 | 0 | 99.86759 | 0 | 0.038759 | 0 |
| DGL 102380 | 4 | 0 | 99.880893 | 0 | 0.033435 | 0 |
| DGL 102381 | 3 | 0 | 99.898353 | 0 | 0.037981 | 0 |
| DGL 102381 | 4 | 0 | 99.908846 | 0 | 0.030595 | 0 |
| DGL 102382 | 3 | 0 | 99.9Q4062 | 0 | 0.045758 | 0 |
| DGL 102382 | 4 | 0 | 99.916735 | 0 | 0.039215 | 0 |
| DGL 102383 | 3 | 0 | 99.930764 | 0 | 0.016924 | 0 |
| DGL 102383 | 4 | 0 | 99.927146 | 0 | 0.019331 | 0 |
| DGL 102384 | 3 | 0 | 99.923541 | 0 | 0.027027 | 0 |
| DGL 102384 | 4 | 0 | 99.933479 | 0 | 0.023196 | 0 |
| DGL 102385 | 3 | 0 | 99.93179 | 0 | 0.021075 | 0 |
| DGL 102385 | 4 | 0 | 99.93299 | 0 | 0.019637 | 0 |
| DGL 102386 | 3 | 0 | 99.923253 | 0 | 0.044611 | 0 |
| DGL 102386 | 4 | 0 | 99.933224 | 0 | 0.03647 | 0 |
| DGL 102387 | 3 | 0 | 99.924189 | 0 | 0.026236 | 0 |
| DGL 102387 | 4 | 0 | 99.924871 | 0 | 0.027926 | 0 |
| DGL 102388 | 3 | 0 | 99.905842 | 0 | 0.053371 | 0 |
| DGL 102388 | 4 | 0 | 99.912012 | 0 | 0.049435 | 0 |
| DGL 102389 | 3 | 0 | 99.922425 | 0 | 0.020137 | 0 |
| DGL 102389 | 4 | 0 | 99.926142 | 0 | 0.018617 | 0 |
| DGL 102390 | 3 | 0 | 99.908695 | 0 | 0.042902 | 0 |
| DGL 102390 | 4 | 0 | 99.921124 | 0 | 0.035131 | 0 |
| DGL 102391 | 3 | 0 | 99.909202 | 0 | 0.04538 | 0 |
| DGL 102391 | 4 | 0 | 99.913362 | 0 | 0.024064 | 0 |
| DGL 102392 | 3 | 0 | 99.846164 | 0 | 0.064833 | 0 |
| DGL 102392 | 4 | 0 | 99.853207 | 0 | 0.061795 | 0 |
| DGL 102393 | 3 | 0 | 99.911169 | 0 | 0.048474 | 0 |
| DGL 102393 | 4 | 0 | 99.919383 | 0 | 0.047429 | 0 |
| DGL 102394 | 3 | 0 | 99.885142 | 0 | 0.032316 | 0 |
| DGL 102394 | 4 | 0 | 99.90045 | 0 | 0.027792 | 0 |
| DGL 102395 | 3 | 0 | 99.928225 | 0 | 0.039301 | 0 |
| DGL 102395 | 4 | 0 | 99.927592 | 0 | 0.041412 | 0 |
| DGL 102396 | 3 | 0 | 99.873767 | 0 | 0.0412 | 0 |
| DGL 102396 | 4 | 0 | 99.883627 | 0 | 0.036541 | 0 |
| DGL 102397 | 3 | 0 | 99.925653 | 0 | 0.037031 | 0 |
| DGL 102397 | 4 | 0 | 99.92597 | 0 | 0.039479 | 0 |
| DGL 102398 | 3 | 0 | 99.888992 | 0 | 0.026459 | 0 |
| DGL 102398 | 4 | 0 | 99.907444 | 0 | 0.017358 | 0 |
| DGL 102399 | 3 | 0 | 99.916822 | 0 | 0.03407 | 0 |
| DGL 102399 | 4 | 0 | 99.934296 | 0 | 0.026556 | 0 |
| DGL 102400 | 3 | 0 | 99.860421 | 0 | 0.046688 | 0 |
| DGL 102440 | 4 | 0 | 99.878407 | 0 | 0.037076 | 0 |

TABLE 4

| | Area PO/area |
|---|---|
| Composition | propene (%) |
| SiMo_{0.022} W_{0.022} Mn_{0.022}Bi_{0.022}Ag_{0.022}O_{1.99}(CH₃)_{0.25} | 0.0116 |
| SiMo_{0.0183}W_{0.0183} Sb_{0.0183}Bi_{0.0183} Mn_{0.0183} | 0.0173 |
| Ag_{0.0183}O_{2.00}(CH₃)_{0.25} | |
| SiMo_{0.0183}W_{0.0183} Cr_{0.0183}Bi_{0.0183} Mn_{0.0183} | 0.0076 |
| Ag_{0.0183}O_{2.00}(CH₃)_{0.25} | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A reactor for carrying out parallel reactions comprising
a) a sample holder capable of holding
b) a multiplicity of reaction vessels,
c) a heated support structure for the sample holder, and
d) a cover sealing all of the reaction vessels which includes:
(1) feed lines and
(2) discharge lines
to each reaction vessel which feed lines and/or discharge lines are joined together by means of
e) feed and/or discharge channels running crosswise to the feed lines and/or discharge lines which feed and/or discharge channels end in
f) a main fluid feed line and/or discharge line.

2. The reactor of claim 1 in which the cover is in two parts, an upper part and a lower part, with the upper part containing the feed and discharge channels.

3. The reactor of claim 1 in which the cover has a plate with bored holes in which the number of bored holes corresponds to the number of reaction vessels.

4. The reactor of claim 3 in which the plate with bored holes is provided with a multiplicity of septa or a septum plate with one septum assigned to each reaction vessel.

5. The reactor of claim 4 in which the septa or the septum plate are arranged over the feed line (d) (1).

6. The reactor of claim 4 in which the septa are composed of rubber.

7. The reactor of claim 1 in which the reaction vessels are arranged in a matrix of at least 100 in the sample holder.

8. The reactor of claim 1 in which a plurality of mass rate of flow controllers is provided in the region of the main fluid feed line.

9. The reactor of claim 1 in which the reaction vessels are connected to a chromatography system.

10. The reactor of claim 9 in which the chromatography system is a gas chromatography system.

11. The reactor of claim 9 in which a connection is made between a program-controlled sampling head that is movable in the x, y and z direction and has a plurality of sample capillaries which are able to dip into the reaction vessels through a septum plate for the collection of individual samples.

12. A process for carrying out parallel test reactions, particularly of catalyst material, comprising:
a) introducing a series of first reactants (A) into a set of reaction vessels,
b) adding reactants (B) and, optionally (C) to the reactants (A) to form a library of reaction mixtures M₁-Mₖ,
c) allowing the reaction mixtures M₁-Mₖ to react, optionally at elevated temperature, over a specified period with the formation of inorganic solids, optionally
d) removing any volatile compounds from the solids F₁-Fₖ at elevated temperature to form catalysts K₁-Kₖ, and
e) conducting, in parallel, catalyzed gas phase reactions on the catalysts K₁-Kₖ formed in d),
f) analyzing the reaction products of the gas phase reaction, and
g) selecting suitable catalysts from those tested on the basis of their efficiency relative to the gas reaction.

13. The process of claim 12 in which the parallel reaction e) is carried out in a reactor comprising
a) a sample holder capable of holding
b) a multiplicity of reaction vessels,
c) a heated support structure for the sample holder, and
d) a cover sealing all of the reaction vessels which includes:
(1) feed lines and
(2) discharge lines
to each reaction vessel which feed lines and/or discharge lines are joined together by means of
e) feed and/or discharge channels running crosswise to the feed lines and/or discharge lines which feed and/or discharge channels end in
f) a main fluid feed line and/or discharge line.

14. The process of claim 9 in which the reactant A) is a metal salt or semi-conductor salt, nitrate, sulfate, oxide, acetate, acetylate, carbonate, carboxylate or alkoxide.

15. The process of claim 14 in that the metal is selected from Ti, Zr, Hf, Sc, Y, La, V, Nb, Ta, Cr, Mo, W, Mn, Re, Fe, Ru, Os, Co, Rh, Ir, Ni, Pd, Pt, Cu, Ag, Au, Ge, Sn, Sb, Bi, Li, K, Na, Rb, Cs, Mg, Ca, Sr, Ba, B, Al, Si, Ce, Pr, Nd, Dy, Ho, Er, Tm, Yb, and Lu.

16. The process of claim 14 in which a reactant B) and, optionally a reactant C) are included in the reaction mixture.

17. The process of claim 16 in which reactant B) is water or an inorganic solid metal or semi-conductor oxide and reactant C) is a mineral acid, an organic acid, or a basic compound.

18. The process of claim 14 in which reactant A) is a metal carbonate, metal nitrate or metal carboxylate which changes to an oxidic solid catalyst due to thermal decomposition.

19. The process of claim 12 in which the gaseous reactants for the catalyzed reaction e) are propylene, oxygen, and optionally, hydrogen.

20. The process of claim 12 in which the gaseous reactants for the reaction e) are mixed prior to the reaction with an inert gas in a ratio of volumes of at most 70:30 (reactants to inert gas).

21. The process of claim 19 in which the amount of propylene oxide formed in reaction e) is used as a measure of the efficiency of the solid catalyst.
